(19) United States
(12) Patent Application Publication
(10) Pub. No.: US 2023/0071299 A1
(43) Pub. Date: Mar. 9, 2023

(54) SYSTEM FOR HAZARDOUS MATERIAL DESTRUCTION

(71) Applicant: Plasma Tech Holdings, LLC, Bedford, NH (US)

(72) Inventor: James Charles Juranitch, Fort Lauderdale, FL (US)

(21) Appl. No.: 17/795,456

(22) PCT Filed: Jan. 25, 2021
(86) PCT No.: PCT/US2021/014966

§ 371 Date: Jul. 26, 2022

Related U.S. Application Data
(60) Provisional application No. 62/966,952, filed on Jan. 28, 2020.

(51) Int. Cl. B09B 3/40; B09C 1/06; C02F 1/02; C02F 1/28

(52) U.S. Cl. CPC B09B 3/40; B09C 1/06; C02F 1/025; C02F 1/283; C02F 2101/36

(57) ABSTRACT

Embodiments of the present disclosure relate generally to a method, apparatus and system for the destruction of hazardous material including Per- and Polyfluoroalkyl substances. The method, apparatus and system can include non-concentrated hazardous material or the concentration of the hazardous material into granular activated charcoal or other absorbents and a vacuum controlled loading system for a re-usable or non-reusable container to minimize leakage of the hazardous material into the atmosphere.

### FIELD OF THE INVENTION

Embodiments of the present disclosure relate generally to a method, apparatus and system for the destruction of hazardous material including Per- and Polyfluoroalkyl substances.

### BACKGROUND

Unfortunately, a by-product of modern society is the generation of many hazardous materials including “Forever Chemicals” that are hazardous to humans and other living things, such as Per- and Polyfluoroalkyl substances known generally as chemicals related to the PFAS, perfluorooctanoic acid (PFOA) or perfluorohexane (PFHx5) family of chemicals.

The Per- and Polyfluoroalkyl substances in particular have accumulated in much of the surface and drinking water of the world. Water is a willing carrier media for the hazardous material. The hazardous material is also present in large quantities of soil and other common carrier media. Extremely small quantities of this hazardous material can have a detrimental effect on humans and other living things. Many studies show levels as low as 70 parts per trillion can have a long-term negative effect on humans. Few processes have been found to separate and concentrate these extremely dilute levels of this hazardous material from its carrier.

Processes used to separate and concentrate this hazardous material from its carrier media that appear to be successful are the use of absorbent “sponges” such as Granulated Activated Carbon (GAC). In this process, large quantities of carrier medias such as water can be stripped of the

Per- and Polyfluoroalkyl substances and other hazardous materials by filtering the water through a GAC container. The hazardous material is then concentrated in the GAC material.

Other materials such as contaminated soils cannot be so easily concentrated. Once the hazardous material is sequestered in a concentrated or non-concentrated form, a method to process the material to successfully render the hazardous material safe to humans and other living things is needed.

### BRIEF DESCRIPTION OF THE DRAWINGS

FIG. 1 depicts a system for the destruction of hazardous material including Per- and Polyfluoroalkyl substances while processing reusable GAC or other hazardous media modules, in accordance with embodiments of the present disclosure.

FIG. 2 depicts a view of a system for the destruction of hazardous material including Per- and Polyfluoroalkyl substances while processing disposable GAC or other hazardous media modules, in accordance with embodiments of the present disclosure.

### DETAILED DESCRIPTION

Embodiments of the present disclosure relate generally to a method, apparatus and system for the destruction of hazardous material including Per- and Polyfluoroalkyl substances before or after it is concentrated into a re-usable or non-reusable container. The Per- and Polyfluoroalkyl substances in particular can accumulate in a carrier that is a fluid, a Granulated Activated Carbon, or other type of carrier. In an example, water is a willing carrier media for the hazardous material. The hazardous material is also present in large quantities of soil and other common carrier media.

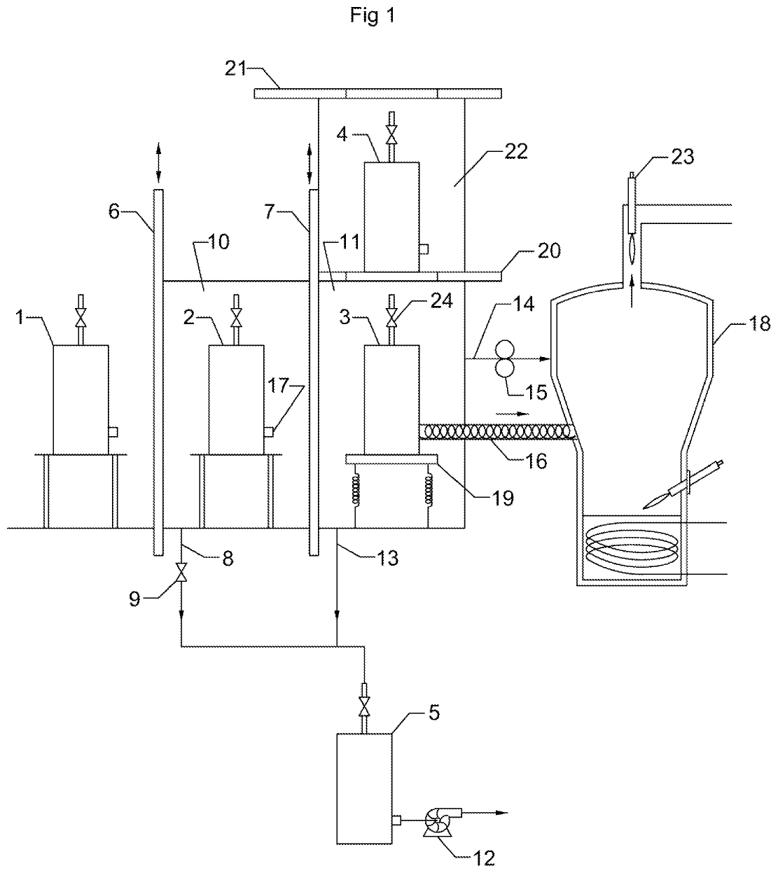

FIG. 1 depicts a system for a loading and destruction process for hazardous or at least one of Per- and Polyfluoroalkyl substances in concentrated or non-concentrated forms trapped in media such as soil or activated charcoal. The system can include media containers 1, 2, 3, 4, and 5. Examples of the media containers can include Protect TW containers, commercially available from Calgon Carbon, although examples are not so limited and other types of containers can be used.

In FIG. 1, media container 1 can be in a pre-loading position. Embodiments of the present disclosure can include a vacuum controlled loading system, as described herein. For example, the system can include an air lock door 6. An example of a loading cycle to perform the destruction of hazardous materials and other substances such as Per- and Polyfluoroalkyl substances initiates with the opening of air lock door 6. Air lock door 6 when closed contains chamber 10, which is preferentially kept at a slight vacuum to minimize leakage of hazardous material to the surrounding atmosphere. Chamber 10 can be reduced to a vacuum by conduit 8, which is in communication with valve 9 and GAC container 5, which is induced into a vacuum condition by pump 12. When air lock door 6 is opened, control valve 9 may be closed to maintain a vacuum in conduit 13. As depicted, conduit 13 can be in communication with chamber 11. When air lock door 6 is closed, valve 9 can be actuated open and can draw a vacuum in chamber 10, the vacuum being approximately equal to the one in chamber 11. When chamber 10 and 11 are approximately equal in vacuum, air lock door 7 can open and the second container 2 can be advanced to a location where the third container 3 is depicted. The vacuum in volume 11 or 10 may be supplemented or controlled by a pump such as a positive displacement pump shown as item 15 in communication with conduit 14, which is in communication with any combination of chambers 11, 10, 22 and 18.

As depicted with respect to the third container, a feed system 16, shown as an auger system but not limited to an auger system, can be advanced into a container port 17 and can unload the hazardous media in the third container 3 into the high temperature thermal chamber 18. In an example, the container port 17 can be an access lumen defined in a surface of the container. In some embodiments, the access lumen can be sealed by a fluid tight seal that can be penetrated by the auger system.

The high temperature thermal chamber 18 can be any vessel which maintains a high temperature for a defined period of time to destroy the hazardous material. The temperature can be equal to or greater than 900 degrees C. for greater than 2 seconds of residence time or greater than 1,100 degrees C. for greater than 2 seconds of residence time, or preferably a higher temperature. The higher the temperature in chamber 18 the shorter the required residence time to destroy most hazardous materials. The thermal chamber 18 can be a plasma assisted chamber, as described in U.S. Pat. No. 10,539,043, which is hereby incorporated by reference as though fully set forth herein. The thermal chamber can be capable of operating at over 1,650 degree C. for many seconds.

Although not required, the third container can be assisted in its unloading by the addition of a shaker table, as shown as item 19. Valve 24 can be coupled with a pressurized conduit, not shown, and opened to pressurize the container 3, to aid in the unloading process. The unloaded container may advance through air lock door 20 into a location where a fourth container 4 is depicted in FIG. 1. Chamber 22 can be held at a vacuum by the methods described for chambers 10 and 11 (not shown for clarity). Container 4 can be ejected through air lock door 21 when the load cycle is complete.

Thermal chamber 18 can be a plasma assisted chamber, as described in U.S. Pat. No. 10,539,043, or any other high temperature chamber. The thermal chamber 18 can have a duct fired plasma torch 23, which is further discussed in U.S. Pat. No. 10,539,043 and an after burner, scrubber, bag house and/or other emission attenuation post treatment processes.

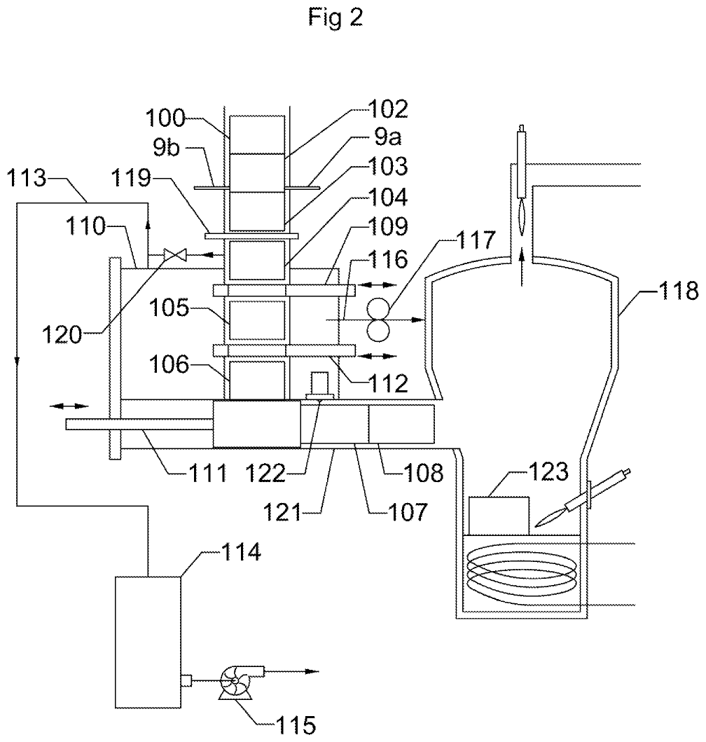

FIG. 2 depicts a system for a loading and destruction process for hazardous or Per- and Polyfluoroalkyl substances in concentrated or non-concentrated forms utilizing media such as soil or activated charcoal. The system can include media containers 100, 102, 103, 104, 105, 106, 107, 108 and 123. These containers can be non-recyclable and can be intended for a single use. When being processed by a plasma assisted chamber 118, as described in U.S. Pat. No. 10,539,043, the containers can be made out of any material that is reduced by the conditions in the plasma assisted chamber 118. Typically, the operating conditions in the plasma assisted chamber are at a temperature in excess of 1,650 degrees C.

A loading cycle, in which a non-reusable container is loaded into a high temperature thermal chamber for processing and destruction, can begin at the location of first container 100. Non-reusable first and second containers 100 and 102 are in a staging area. This area can contain as many containers as desired. Loading mechanisms 9a and 9b can include fingers that retract to drop a container into a location where the third container 103 is depicted. Loading mechanisms 9a and 9b can then advance to halt the approach of any additional containers, after dropping a container into the location where the third container 103 is depicted.

Embodiments of the resent disclosure can include an air lock door 119, which can be used to isolate a location where a fourth container 104 is depicted from the atmosphere. The air lock door 119 can retract to an open position and drop the third container 103 to a location of where the fourth container 104 is depicted, after control valve 120 is closed to maintain a vacuum to chamber 110. When the third container 103 drops to the location of where the fourth container 104 is depicted, the air lock door 119 can close and control valve 120 can open to induce a vacuum in the location of where the fourth container 104 is depicted in FIG. 2. After a vacuum is induced in the location of where the fourth container 104 is depicted, the amount of vacuum being approximately equal to that in chamber 110, the air lock 109 can open and drop the container to location 105. Air lock 109 can be used to isolate chamber 110 from location 104. Air lock door 112 can be used to isolate the thermal chamber 118 from chamber 110. The thermal chamber 118 can also typically be controlled via a vacuum produced from its own evacuation system, as described in U.S. Pat. No. 9,926,217, which is hereby incorporated by reference as though fully set forth herein.

Chamber 110 can be controlled in a vacuum state to avoid leakage of hazardous material into the atmosphere. Chamber 110 may be drawn to a vacuum by conduit 113, which is in communication with chamber 110 and container 114 which could be activated charcoal used to strip hazardous material from the atmosphere in chamber 110. Container 114 can be in communication with pump 115, which can be used to draw a vacuum in container 114. The vacuum in chamber 110 may be supplemented or controlled by conduit 116, which is in communication with pump 117, which may be a positive displacement pump.

Loading piston system 111 is shown in an advanced location. When piston 111 retracts, a container from the location of where the sixth container 106 is depicted can drop into the thermal chamber loading tube 121. The container in the location of where the seventh container 107 is depicted may be pierced by punch 122 to help control its pressure release when it is processed in chamber 118. In an example, the punch 122 can be advanced such that it pierces a top of a container in the location of where the seventh container 107 is depicted. Although the punch 122 is depicted in a location above the seventh container 107, the punch could be located at numerous locations with respect to the container (e.g., to the side, bottom, etc.). As the loading cycle continues, the containers advance into their final location 123 where they undergo the process of thermal destruction. For example, after being punched by the punch 122, the seventh container 107 can be advanced to a location of the eighth container 108, which can then be advanced into the chamber 118, as depicted with container 123.

Embodiments are described herein of various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment”, or the like, means that a particular feature, structure, or characteristic described in connection with the embodiment(s) is included in at least one embodiment. Thus, appearances of the phrases “in various embodiments,” “in some embodiments,” “in one embodiment,” or “in an embodiment,” or the like, in places throughout the specification, are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

Although at least one embodiment for a hazardous material destruction system has been described above with a certain degree of particularity, those skilled in the art could make numerous alterations to the disclosed embodiments without departing from the spirit or scope of this disclosure. All directional references (e.g., upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the devices. Joinder references (e.g., affixed, attached, coupled, connected, and the like) are to be construed broadly and can include intermediate members between a connection of elements and relative movement between elements. As such, joinder references do not necessarily infer that two elements are directly connected and in fixed relationship to each other. It is intended that all matter contained in the above description or shown in the accompanying drawings shall be interpreted as illustrative only and not limiting. Changes in detail or structure can be made without departing from the spirit of the disclosure as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

1. A system for the destruction of a hazardous material, the system comprising:
a thermal chamber to break down the hazardous material via thermal processing; and
a vacuum controlled loading system configured to minimize a leakage of the hazardous material into a surrounding environment.

2. A system for the destruction of a hazardous material, the system comprising:
a plasma assisted thermal chamber to break down the hazardous material;
and a vacuum controlled loading system configured to minimize a leakage of the hazardous material into a surrounding environment.

3. The system as in any one of claim 1 or 2, wherein the hazardous material includes at least one of Perfluoroalkyl and Polyfluoroalkyl substances.

4. The system as in any one of claim 1 or 2, wherein the hazardous material includes at least one of Perfluoroalkyl and Polyfluoroalkyl substances that have been stripped and concentrated from a carrier media into an absorbent material.

5. The system of claim 4, wherein the carrier media is a fluid.

6. The system of claim 4, wherein the carrier media includes water.

7. The system of claim 4, wherein the absorbent material includes activated charcoal.

8. The system of claim 4, wherein the absorbent material includes granular activated charcoal.

9. The system as in any one of claim 1 or 2, wherein the hazardous material includes at least one of Perfluoroalkyl and Polyfluoroalkyl substances that have been stripped and concentrated from a carrier media into an absorbent material and processed for destruction in a re-usable vessel.

10. The system as in any one of claim 1 or 2, wherein the hazardous material includes at least one of Perfluoroalkyl and Polyfluoroalkyl substances, the at least one of the Perfluoroalkyl and Polyfluoroalkyl substances being stripped and concentrated from a carrier media into an absorbent material and processed for destruction in a non-reusable vessel, wherein the vessel is fed into and processed for destruction in the thermal chamber.

11. The system as in any one of claim 1 or 2, wherein the hazardous material includes at least one of Perfluoroalkyl and Polyfluoroalkyl substances that are stripped and concentrated from a carrier media into an absorbent material and processed for destruction in a non-reusable vessel which is punctured to aid in its pressure release during the thermal processing.

12. The system as in any one of claim 1 or 2, wherein the hazardous material includes at least one of Perfluoroalkyl and Polyfluoroalkyl substances, and wherein the hazardous material is not concentrated from a carrier media before being processed for destruction in a re-usable vessel.

13. The system as in any one of claim 1 or 2, wherein the hazardous material includes at least one of Perfluoroalkyl and Polyfluoroalkyl substances, and wherein the hazardous material is not concentrated from a carrier media before being processed for destruction in a non-reusable vessel.

14. The system as in any one of claim 1 or 2, wherein the hazardous material includes at least one of Perfluoroalkyl and Polyfluoroalkyl substances, wherein the hazardous material is not concentrated from a carrier media before being processed for destruction in a non-reusable vessel, wherein the non-reusable vessel is punctured to aid in thermal processing before it is fed into the thermal chamber and processed for destruction.
